(19) United States
(12) Patent Application Publication
(10) Pub. No.: US 2023/0244469 A1
(43) Pub. Date: Aug. 3, 2023

(54) FIRMWARE UPDATE WITH AN IMAGE

(71) Applicant: KYOCERA Document Solutions Inc., Osaka (JP)

(72) Inventors: Zsolt Hajdu, Torrance, CA (US); David Shamtoub, Los Angeles, CA (US)

(21) Appl. No.: 17/588,127

(22) Filed: Jan. 28, 2022

(51) Int. Cl. G06F 8/65; G06F 11/07; G06F 11/08; G06F 8/52

(52) U.S. Cl. CPC G06F 8/65; G06F 11/0733; G06F 11/08; G06F 8/52

(57) ABSTRACT

Systems and methods relating generally to firmware updating with an image are disclosed. In an example method thereof, an image graphically representing a binary file is obtained. The image is input via an optical-to-electric converter into an electronic device. The image input is processed by the electronic device to recreate the binary file in a binary form. Firmware of the electronic device is updated with the binary file in the binary form.

### FIELD

The following description relates to a firmware update. More particularly, the following description relates to updating firmware with an image.

### BACKGROUND

Conventionally, in office and production electronic devices, features and/or settings are immediately available based on factory set defaults. A printer, such as a multi-function printer (“MFP”), a production printer, or a personal printer, come pre-configured with a configuration programmed into such device during via printer firmware. When such a printer is turned ON, its user interface or device panel conventionally shows its initial configuration as pre-defined, such as from a factory.

### SUMMARY

In accordance with one or more below described examples, a method relating generally to firmware updating with an image is disclosed. In such a method, an image graphically representing a binary file is obtained. The image is input via an optical-to-electric converter into an electronic device. The image input is processed by the electronic device to recreate the binary file in a binary form. Firmware of the electronic device is updated with the binary file in the binary form.

In accordance with one or more below described examples, another method relating generally to firmware updating with an image is disclosed. In such a method, an image textually representing a binary file is obtained. The image is input via an optical-to-electric converter into an electronic device. The image input is processed by the electronic device to recreate the binary file in a binary form. Firmware of the electronic device is updated with the binary file in the binary form.

In accordance with one or more below described examples, a system relating generally to firmware updating with an image is disclosed. In such a system, a memory is configured to store program code for a firmware service. A processor is coupled to the memory, wherein the processor, in response to executing the program code, is configured to initiate operations for implementing a firmware update by the firmware service including: inputting into an electronic device via an optical-to-electric an image graphically representing a binary file; processing by the electronic device the image input to recreate the binary file in a binary form; and updating firmware of the electronic device with the binary file in the binary form.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1 is a flow diagram depicting an example of a firmware update flow.

FIG. 2-1 is a pictorial diagram depicting an example of an image of a binary image-type file.

FIG. 2-2 is a pictorial diagram depicting an example of an image of a binary hex-type numerical list file.

FIG. 2-3 is a pictorial diagram depicting an example of an image of a binary QR-code type file.

FIG. 3 is a block diagram depicting an example of a mobile firmware update system.

FIG. 4 is a pictorial diagram depicting an example of a network.

FIG. 5 is block diagram depicting an example of a portable communication device.

FIG. 6 is a block diagram depicting an example of a multi-function printer.

FIG. 7 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

Generally, in scanners, multi-function printers (“MFPs”), and other electronic devices there is internal software stored in solid-state or other memory, called firmware. This internal software or firmware may be used to operate such electronic devices. Occasionally this firmware may be updated, such as for example to correct one or more software, hardware or other problems. In other instances, a firmware update may be used to include one or more added features for example. Updating the firmware may not be a straightforward process, involving a service technician or at least some one with substantial familiarity with hardware to download a proper firmware build and correctly install such downloaded firmware.

Sometimes a firmware/software bug can disable communication channels of an MFP. If for example both network communication and a USB port are nonoperational or disabled. If both a network port/interface and a USB port are nonoperation or disabled, a firmware update to fix such firmware/software bug thus may be precluded by going through such ports.

Another use example may be if a firmware update has to be done very urgently and there is no time for a service technician to go to a customer's site. In that situation a user may have to do a firmware update. However, a user might not be familiar with a procedure for updating firmware through a network or USB drive. In such a situation, it may be useful to have a firmware update procedure that only uses basic scanning and control panel instructions.

As described below in additional detail, an update firmware through image scan may be provided to allow even an inexperienced user to update firmware. Updating firmware through image scan may be used in many different instances. For example, if electronic communication with running firmware is not possible for some reason. It is possible for example that a software bug or malware in running firmware disables network and USB communication; or, such as for security reasons like a ransomware attack on a device, network, USB, or other interfaces are intentionally disabled. Furthermore, in some instances an electronic device may not be able to be connected to a network or USB port for security reasons, and so updating firmware through image scan may be useful.

With the above general understanding borne in mind, various configurations for updating firmware through image scan are described below.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc. may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

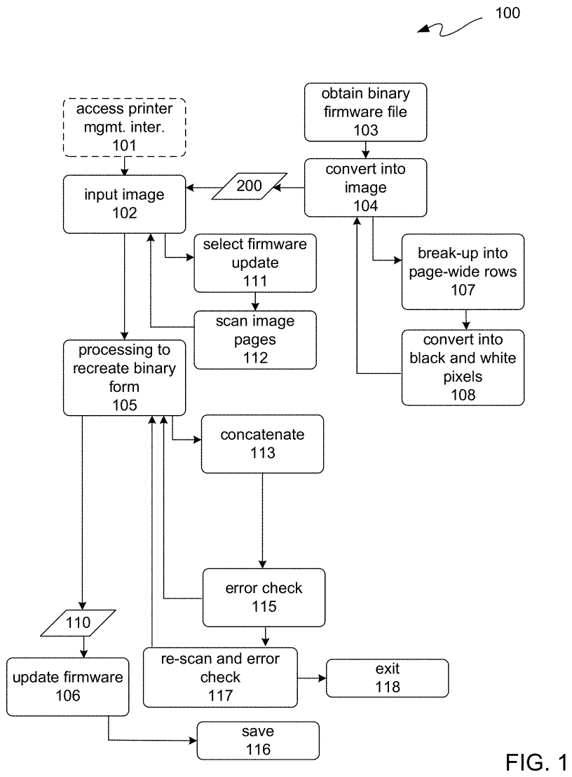

FIG. 1 is a flow diagram depicting an example of a firmware update flow 100. Optionally, if available, a printer management user interface (“UI”) 101 may be accessed, such as via a touch screen or other display screen of a multi-function printer (“MFP”). The following description is for an MFP for purposes of clarity by way of example and not limitation. Along those lines, from the following description it will be understood than any electronic device having updateable or generally re-writeable firmware may be used.

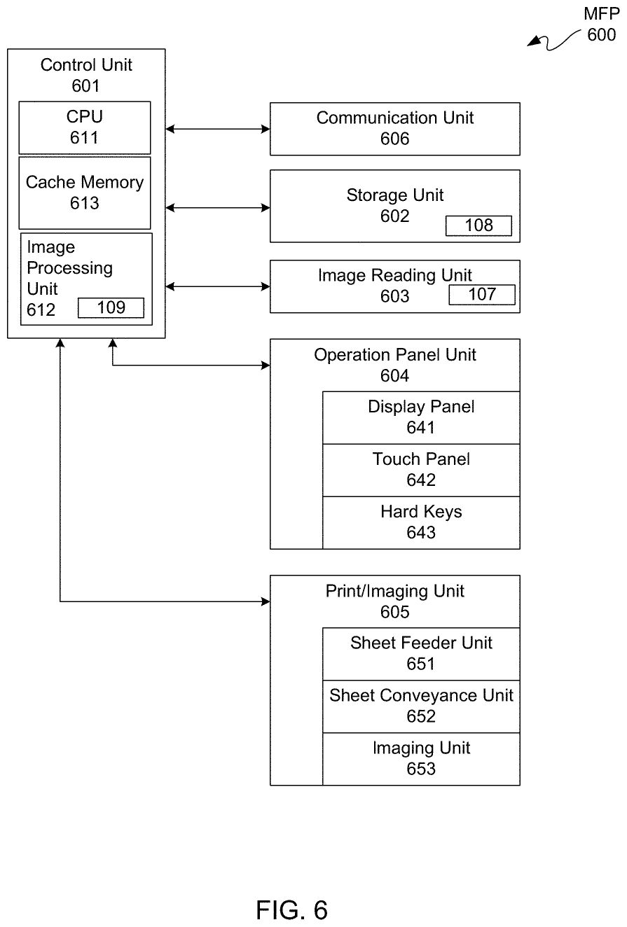

In some instances, access to a UI may not be available, in such an instance a hard reset may be used to automatically invoke a firmware update service, as described below in additional detail. At operation 102, an image of a binary file may be input to an MFP, such as for example MFP 600 of FIG. 6. In this example, MPF 600 has firmware 108 stored in memory of storage unit 602. In another example, firmware 108 may be part of a CPU 611 or elsewhere in MFP 600.

Moreover, MFP 600 of FIG. 6 may include an optical-to-electric converter 107 of an image reading unit 603. In an example, optical-to-electric converter 107 may be an imager. Such an imager may be selected from a charge-coupled device or an active pixel sensor. In this example, such an imager is a digital imager. Furthermore, in this example such an imager is a focal-plane array of a digital scanner of an MFP.

However, in another example, an MFP or other electronic device may include a digital camera or a port for input of digital camera images or a memory card interface port for input of digital camera images stored thereon. For example, a high-resolution digital camera can be used to take pictures of a printed, paper copy of a graphical representation of a binary file for a firmware update, and such pictures may be input to such MFP at operation 102.

Returning to FIG. 1, an image input at operation 102 may be of a graphical representation of a binary file. In this example, such a graphical representation may be input to an MFP by scanning an image into such MFP using an imaging unit thereof.

A user may download, or receives it as an email attachment, a graphical representation of a binary file in pdf or another printable format. A user may print out such a graphical representation on a printer. Optionally, a user can receive a paper copy of graphical representation of a firmware binary file by mail.

With a printed copy of a firmware binary file available, a user may select a firmware update function, such as on printer's control panel for example, at operation 111. Such a firmware update function may guide a user through firmware updating steps. At operation 112, a user may scan printed pages representing a firmware binary file, as described herein. For example, a user may be prompted to scan printed pages using a scanner function on an MFP. Then a firmware service may internally process such scanned data at operation 105 to recreate a firmware binary file internally in such MFP and start a firmware update process.

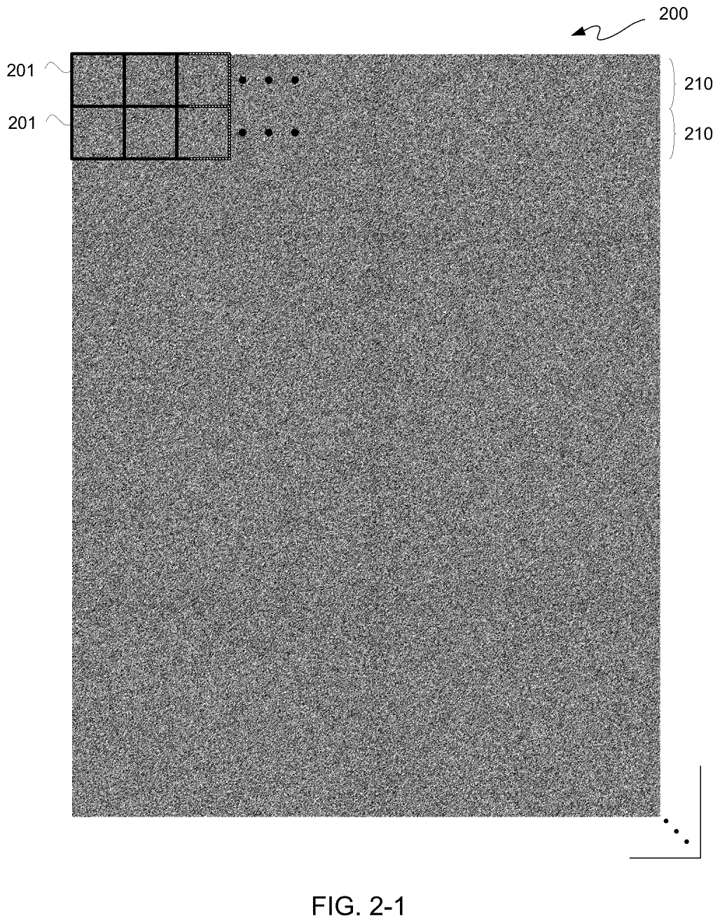

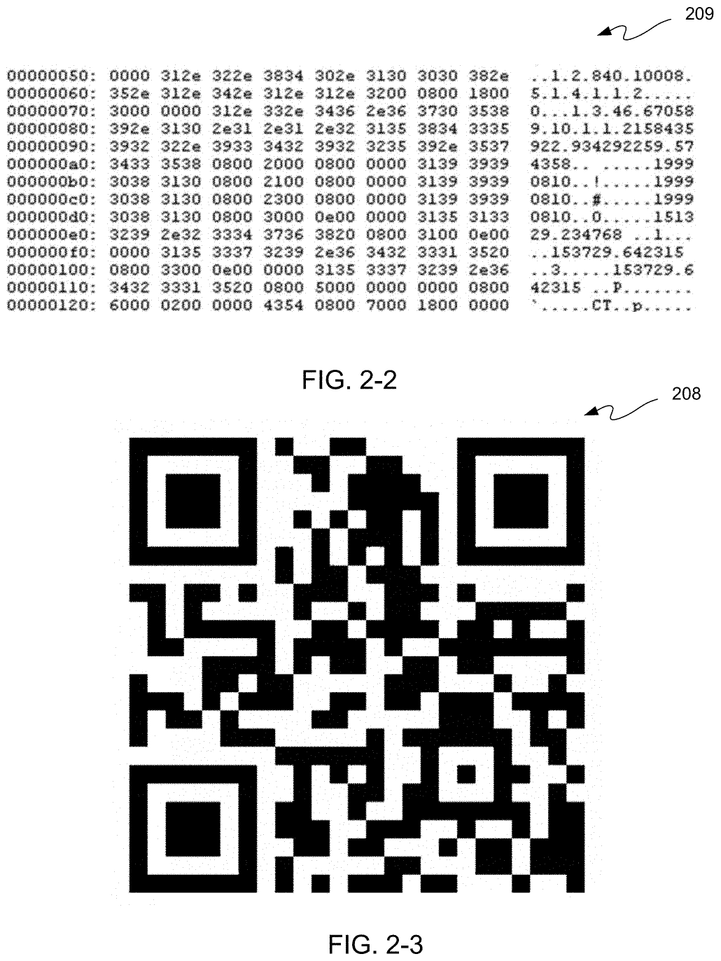

FIG. 2-1 is a pictorial diagram depicting an example of an image 200 of a binary image-type file. In this example, rather than using a listing of hex or other numerical values arranged in an array, image 200 includes rows 210 of pixel regions 201 having dots 202 therein. Dots 202 in pixel regions 201 may represent one or more values, such as HEX or other binary file format values.

However, in other examples, other types of images may be used. For example, FIG. 2-2 is a pictorial diagram depicting an example of an image 209 of a binary hex-type numerical list file. In this example, an image processing unit 612 of MFP 600 may be configured with an optical character recognition (“OCR”) module 109 or like module to convert such image 200 into a binary file format suitable for direct reading by an MFP for purposes of a firmware update. However, for purposes of clarity by way of example and not limitation, a binary image-type file format, such as of FIG. 2-1 for example, is further described.

Conventionally, format of a firmware update is a file that can be downloaded, such as from the Internet for example. Such a firmware update file may contain multiple files. These multiple files or single file may be “zipped” or compressed into a single binary file, such as in the example of FIG. 2-2.

However, for binary image-type file format, a binary firmware file may be obtained at operation 103 and converted into graphical format at operation 104 to provide a binary image-type file 200 for input at operation 200.

In this example, bytes of such a binary firmware file may at operation 104 be a sequence which may be broken up into pages at operation 107 thereof, and at operation 104 such bytes of such pages may be converted to black and white pixels at operation 108 thereof. In this example, a bit value of 1 means black and a bit value of 0 means white. In this example, a resulting sequence of black and white pixels is broken up into page wide rows 210. Row generated this way can be organized into letter page sized images 200. Images can be stored in a multipage graphics storage format, like pdf, xps or tiff for example.

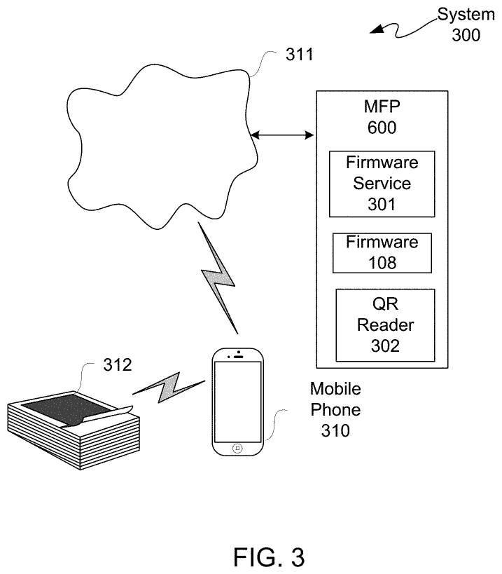

FIG. 2-3 is a pictorial diagram depicting an example of an image 208 of a binary QR-code type file. In another example, high-resolution QR-codes images may be arranged as pages or generated a full pages to provide a multipage graphics storage format. However, again for purposes of clarity by way of example and not limitation, a binary image-type file format, such as of FIG. 2-1 for example, is further described.

Returning to FIG. 1, at operation 105 an input image may be processed by an MFP. Again, such an image input may be a graphical representation of a binary file. At operation 105, a processor of an MFP may be configured, such as with a firmware service configured in such MFP, to recreate a binary file 110 in binary form from such input image 200, including page images from multiple scanned pages. In binary form, such a binary file 110 may be used to directly update firmware of such MFP.

At operation 106, firmware may be updated with such binary file 110 in binary form. By being in binary form, binary file 110 may be directly read or readable by a processor of an MFP for example.

FIG. 3 is a block diagram depicting an example of a mobile firmware update system 300. FIG. 3 is further described with simultaneous reference to FIGS. 1 through 3.

In mobile firmware update system 300, a mobile phone 310 may be used as a camera to take pictures of graphical representations of portions of a binary file respectively printed on sheets of paper in stack of papers 312.

Such pictures may be wirelessly loaded from mobile phone 310 into MFP 600, such as via a cloud connection 311 or other wireless connection. MFP 600 may be configured with a firmware service 301. As described herein, such a firmware service 301 may be configured for inputting such images/pictures, processing such pictures to recreate a binary file in a binary format, and updating firmware 108 of MFP 600 with such binary file.

A mobile phone 310 or a tablet may have a camera for performing input operation 102. Pixels of an optically input image may be convert into a first tone pixels and second tone pixels different from such first tone pixels for image processing, which may be part of a scan operation 112. The printable hardcopy version of the new firmware file can be sent to the customer site where the update needs to be done. The customer has to print the pages of that document on another printer.

Optionally, a hardcopy version of a firmware binary file can be mailed to a customer for future use. Firmware service 108 may be configured with a built-in firmware update “Wizard,” that guides user through the steps of how to do perform an update. A step may be to prompt a user to print a hardcopy firmware update if they don't have a paper copy available. For a scanner operation, there may be a prompt to switch to a scanning mode on an MFP having firmware to be updated. A user may scan a firmware hardcopy through document feeder of such MFP.

Scanning may be done at a resolution higher than the resolution used to print a hardcopy version of a firmware binary file, namely at a higher resolution than used to produce image 200. This may ensure that pixels are detected with a high accuracy. Again, currently running firmware may convert scanned black and white pixels to 1 or 0 bits and put them into concatenated bytes and then optionally pages, and such currently running firmware may save such sequence of bytes into a binary file on an internal hard drive of an MFP. This recreates the original firmware update binary, and such recreated firmware update binary may be used to update what is the currently running firmware.

At operation 105, such first tone pixels and second tone pixels may be converted respectively to first bits and second bits different from such first bits to recreate a binary file 110 in a binary form. Such first bits and second bits may respectively be binary 1 bits and binary 0 bits.

As part of operation 105, at operation 113 portions of such first bits and/or second bits may be concatenated to provide bytes representing such binary form of a binary file 110. Such concatenated sequence bits formed into bytes may be concatenated pages corresponding to operation 104. For example, a sequence of first bits and second bits representing bytes of information of a binary file may be concatenated with page-wide rows, and such page-wide rows may be retain a source organization of scanned pages.

At operation 115, such binary form of an in-process binary file may be checked for errors with an error-detecting code built into binary file data. For example for error checking purposes at operation 115, there may be one additional page after firmware data in a stack of papers 312. This additional page may for example have a cyclic-redundancy check (“CRC”) checksum of an original firmware file. In another example for error checking purposes at operation 115, there may be a CRC checksum at the end of each page of an original firmware file, namely of a stack of pages though in binary form of an in-process binary file. In this latter example, each CRC checksum may be generated and added on a page-by-page basis, for example at the end of each such page, and so at operation 115 an error check may be performed on each page of data of a binary file, as described in additional detail below. This CRC checksum, whether for a stack of pages or for each page, can be photographed/scanned after printing. For example, an update code of firmware service 301 may be configured to determine a CRC checksum from restored/recreated firmware binary data input from such photographed/scanned pages in combination or for each of such pages, and this determined CRC checksum for all pages or for each page may be compared with a corresponding scanned CRC checksum, such as on a last page or on each page, respectively. For a single checksum for a stack of pages, if such two checksums match, then it is assumed that there is no error and so update code proceeds to installation of such update binary file 110 recreated. For example, after all pages are scanned, firmware service 108 calculates the CRC of a reproduced firmware binary and compares it with the input CRC scanned and saved from the very last page of a firmware hardcopy document. If scanned and calculated checksums match, updater code of firmware service 108 proceeds to initiate or continue with a firmware update process. For a respective checksum for each page of a stack, if such two checksums match after scanning for example, then it is assumed that there is no error on such page. Each page may be check, and if a scanned page and corresponding binary file page have matching CRC checksums, then an update code may proceed to a next scanned page for a comparison. If all scanned and corresponding binary page checksums match, updater code of firmware service 108 may proceed to installation of such update binary file 110 recreated, such as continuing at operation 105. For example, after all pages are scanned or after scan of each page, firmware service 108 may calculate a CRC of each page of a reproduced firmware binary and compare it with an input CRC scanned of a corresponding page through to the very last page of a firmware hardcopy document saved. If all scanned and corresponding calculated checksums match, updater code of firmware service 108 may proceed to initiate or continue with a firmware update process, such as for example at operation 105. If, however, one or more of such scanned pages do not have matching CRC checksums, then a user may be prompted to re-scan such pages for rescanning and rechecking such CRC checksums for matches at operation 117. If all re-scans result in matching corresponding CRC checksums, then updater code of firmware service 108 may proceed to initiate or continue with a firmware update process, such as for example at operation 105. If, however, one or more of such rescanned pages do not have matching CRC checksums, which rescanning may be limited to some number such as for example three attempts, then updater code of firmware service 108 may exit at 118 of a firmware update process.

If MFP 600 has a color scanner, color pixels can be used instead of just black and white pixels. Assuming standard CMY (cyan, magenta and yellow) color planes, in the place of one pixel three bits of information can be stored, because all CMY planes can be on or off individually. This way a same binary file can be stored in one-third of the space of a monochrome equivalent.

At operation 106, firmware service 108 causes updating to commence with such recreated firmware update binary file. However, prior to and as part of such updating, at operation 116 bytes of such binary file 110 may be saved into a file format on an internal storage device of storage unit 602 of MFP 600.

Returning to FIG. 1, In another example an input image at operation 102 may be an image of a code listing, such as a binary file represented in either of FIG. 2-2 or 2-3, printed on paper. Such input may be via an optical-to-electric converter for input into an electronic device having firmware.

For FIG. 2-2, processing of a binary file may include OCR to identify characters in such image input to recreate a code listing. This code listing is in a binary format so as to be in a directly computer readable form, namely without any compilation operation. Other operations are as previously described, and thus not repeated for purposes of clarity and not limitation.

For FIG. 2-3, processing of a binary file may include accessing a QR reader 302 of MFP 600 to identify coding in such image input to recreate a code listing. This code listing is in a binary format so as to be in a directly computer readable form, namely without any compilation operation. Other operations are as previously described, and thus not repeated for purposes of clarity and not limitation.

Because one or more of the examples described herein may be implemented in using an information processing system, a detailed description of examples of each of a network (such as for a Cloud-based SaaS implementation), a computing system, a mobile device, and an MFP is provided. However, it should be understood that other configurations of one or more of these examples may benefit from the technology described herein.

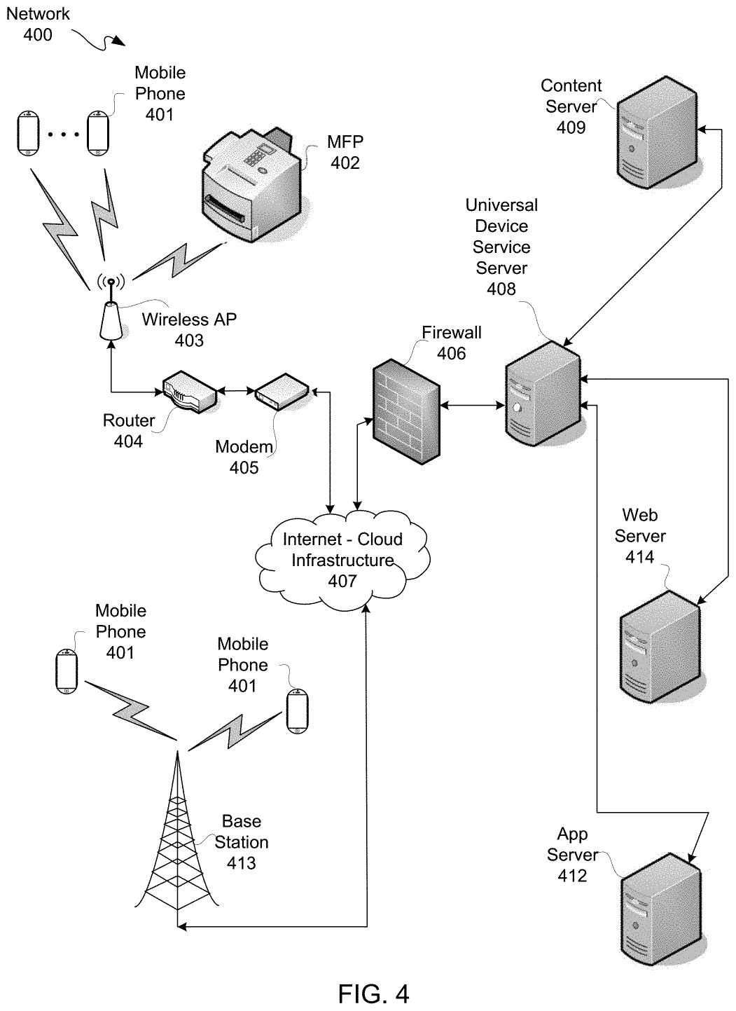

FIG. 4 is a pictorial diagram depicting an example of a network 400, which may be used to provide a SaaS platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401, such as mobile phones, tablets, notebooks, and/or other such device, may be in wireless communication with a base station 413. Additionally, a desktop computer and/or a printing device, such as for example a multi-function printer (“MFP”) 402, each of which may be web-usable devices, may be in wireless and/or wired communication to and from router 404.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

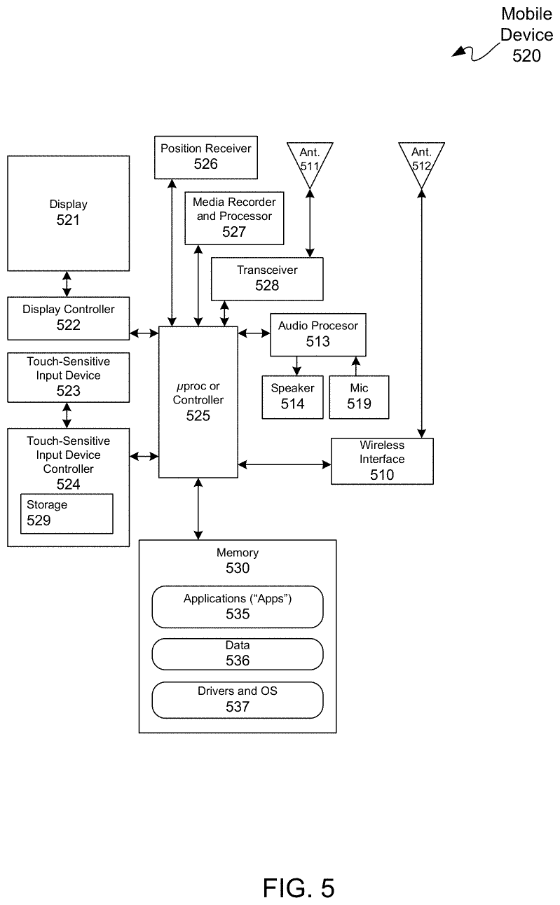

FIG. 5 is block diagram depicting an example of a portable communication device (“mobile device”) 520. Mobile device 520 may be an example of a mobile device, as previously described.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder and processor 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps as described hereinabove may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

FIG. 6 is a block diagram depicting an example of an MFP 600. MFP 600 is provided for purposes of clarity by way of non-limiting example. MFP 600 is an example of an information processing system such as for handling a printer job as previously described. MFP 600 may be an example of an MFP 151 of FIG. 1-2.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices.

Control unit 601 may include a CPU 611, an image processing unit 612, and cache memory 613. Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation any printer resident printer driver components. A buffer queue may be located in cache memory 613 or storage unit 602. Storage unit 602 may store a GUI library or database.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

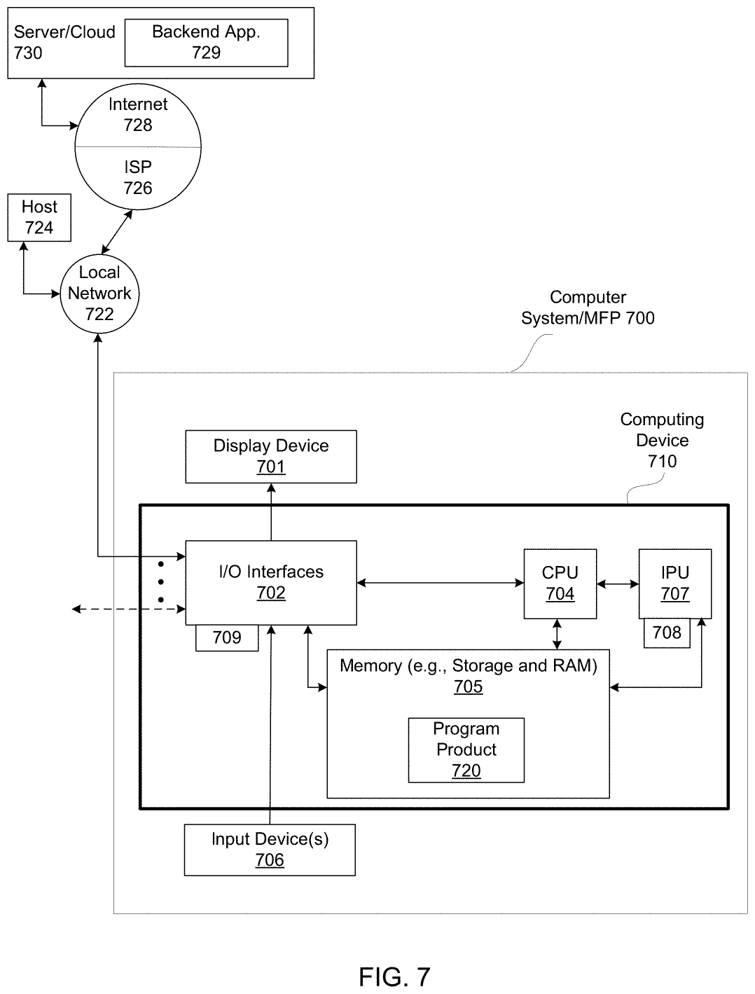

FIG. 7 is a block diagram depicting an example of a computer system 700 upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 may be of an MFP. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCIe bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer- or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application 729 for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

What is claimed is:

1. A method, comprising:
obtaining an image graphically representing a binary file;
inputting the image via an optical-to-electric converter into an electronic device;
processing by the electronic device the image input to recreate the binary file in a binary form; and
updating firmware of the electronic device with the binary file in the binary form.

2. The method according to claim 1, wherein the optical-to-electric converter is an imager.

3. The method according to claim 2, wherein the imager is selected from a charge-coupled device or an active pixel sensor.

4. The method according to claim 2, wherein the imager is a digital imager.

5. The method according to claim 2, wherein the imager is a focal-plane array.

6. The method according to claim 1, wherein the electronic device includes a digital scanner.

7. The method according to claim 1, wherein the electronic device includes a digital camera.

8. The method according to claim 1, wherein the electronic device is configured with a firmware service.

9. The method according to claim 2, wherein the firmware service is configured for the inputting, the processing and the updating.

10. The method according to claim 2, wherein the inputting comprises converting pixels associated with an optical input of the image into a first tone pixels and second tone pixels different from the first tone pixels for image processing.

11. The method according to claim 10, wherein the first tone pixels and the second tone pixels respectively are black pixels and white pixels.

12. The method according to claim 10, wherein the first tone pixels and the second tone pixels are monochrome of different intensities.

13. The method according to claim 10, wherein the first tone pixels and the second tone pixels respectively are pixels of a first color and pixels of a second color different from the first color.

14. The method according to claim 10, wherein the processing comprises converting the first tone pixels and the second tone pixels respectively to first bits and second bits different from the first bits to recreate the binary file in the binary form.

15. The method according to claim 14, wherein:
the first bits and the second bits respectively are binary 1 bits and binary 0 bits; and
the processing further comprises:
concatenating portions of the first bits and the second bits to provide bytes representing the binary form of the binary file; and
error checking the binary form of the binary file with an error-detecting code built into the binary file.

16. The method according to claim 15, wherein:
the electronic device is a multi-function printer; and
the updating comprising saving the bytes into a file format on an internal storage device of the printing device.

17. The method according to claim 15, wherein the processing further comprises:
breaking up a sequence of the first bits and the second bits into page-wide rows; and
organizing the page-wide rows into pages.

18. A method, comprising:
obtaining an image textually representing a binary file;
inputting the image via an optical-to-electric converter into an electronic device;
processing by the electronic device the image input to recreate the binary file in a binary form;
updating firmware of the electronic device with the binary file in the binary form.

19. A system, comprising:
a memory configured to store program code for a firmware service; and
a processor coupled to the memory, wherein the processor, in response to executing the program code, is configured to initiate operations for implementing a firmware update by the firmware service, including:
inputting into an electronic device via an optical-to-electric converter an image graphically representing a binary file;
processing by the electronic device the image input to recreate the binary file in a binary form; and
updating firmware of the electronic device with the binary file in the binary form.

20. The system according to claim 19, wherein:
the optical-to-electric converter is of the electronic device; and
the electronic device is a multi-function printer.
